(19) United States
(12) Patent Application Publication
(10) Pub. No.: US 2017/0208387 A1
(43) Pub. Date: Jul. 20, 2017

(54) Acoustic Resonator for Audio Headphones

(71) Applicant: Donald Pierce Bearden, Little Rock, AR (US)

(72) Inventor: Donald Pierce Bearden, Little Rock, AR (US)

(21) Appl. No.: 15/001,170

(22) Filed: Jan. 19, 2016

(51) Int. Cl. H04R 1/28; H04R 1/10; H04R 5/04

(52) U.S. Cl. CPC H04R 1/2819; H04R 5/04; H04R 1/1066; H04R 2400/03

(57) ABSTRACT

An acoustic resonator device for reproducing sound in audio headphones having acoustic transducers coupled to resonating structures composed of various materials which react to the vibrations of the transducers. The resonator structures are designed with large surface areas by using projections of rigid materials of various shapes, sizes and quantities. These projections also resonate at different frequencies. The acoustic resonator reproduces sound from audio sources without compression waves being directed into the ear. These compression waves emanate from more typical audio drivers found in most headphones and can lead to listening fatigue as well as discomfort. The acoustic resonator device also produces a haptic effect which produces a richer sound, especially in the low frequency range. More than one acoustic transducer and resonator assembly is used to reduce distortion by dividing the frequency response into low and high/mid frequency ranges.

### BACKGROUND

Field of Invention

This invention relates to the design of sound reproduction elements in audio headphones.

Description of Prior Art

Audio headphones are typically designed with diaphragm elements of a compression driver design. These elements produce sound like conventional speakers which generate compression waves from a mechanical diaphragm driven by an electrical signal from an amplifier. Typically, the diaphragm elements are arranged inside the headphone housing so that compression waves are directed straight to the ear. U.S. Pat. No. 7,162,051 to Grell, et al (2007) discloses a headphone design in which the transducer is mounted so that the compression waves are directed into the ear. This arrangement can cause listening fatigue as well as hearing loss from high sound levels.

Most headphones are designed with one diaphragm element which is expected to reproduce the frequencies within the range of human hearing. This is often stated to be between 20-20,000 hertz. These diaphragm elements often cannot accurately reproduce the entire range without some distortion occurring. U.S. Pat. No. 4,418,248 to Mathis (1983) discloses a dual transducer design which divides the audio spectrum between the two transducers. The transducers are also mounted to direct the compression waves into the ear, putting stress on the ear drum.

The haptic effect as it applies to sound reproduction is the physical sensation of sound as well as the hearing of sound. Audiences of live concerts with higher volume levels often experience this “felt” sound, particularly from lower frequencies such as a bass drum beat. This effect is not reproduced very well in conventional headphone design due to the typical low mass of the diaphragm elements. U.S. Pat. No. 8,767,996 to Lin, et al (2014) discloses a headphone design incorporating a haptic transducer in the head band and in the ear pad housings in another drawing. The haptic transducers are not shown to be connected to a resonator assembly and are directed into the ear from the ear pad housings.

### Objectives and Advantages

A. To use acoustic resonance to reproduce sound. No compression diaphragm type driver is employed in the design. This design can reduce listening fatigue.

B. To provide a haptic effect especially in lower frequencies. This produces a fuller, richer sound.

C. To provide for a variety of configurations that enable the acoustic resonator to be tuned for different listening preferences.

D. To provide for lower distortion by incorporating more than one audio transducer element into the acoustic resonator.

### DRAWING FIGURES

FIG. 1 shows the invention incorporated into a typical headphone set for stereophonic music listening. The figure shows one half (one stereo channel) of a two stereo channel headphone set.

FIG. 2 is an exploded diagram of the housing assembly which contains the acoustic resonator assembly, all of which comprises the embodiment of the invention.

FIG. 3 is an exploded diagram of the acoustic resonator assembly, all of which comprises the embodiment of the invention.

FIG. 4 is a front view of the acoustic resonator assembly showing the positions of the low frequency resonator, the high/mid frequency resonator, and the transducers in relation to each other, all of which comprises the embodiment of the invention.

FIG. 5 is a side view of the acoustic resonator assembly showing the positions of the low frequency resonator, the high/mid frequency resonator, and the transducers in relation to each other, all of which comprises the embodiment of the invention.

FIG. 6 is another side view of the acoustic resonator assembly showing the positions of the low frequency resonator and a transducer, all of which comprises the embodiment of the invention.

FIG. 7 is an exploded diagram of the high/mid frequency resonator, all of which comprises the embodiment of the invention.

FIG. 8 is a side view of the high/mid frequency resonator which comprises the embodiment of the invention.

FIG. 9 is a front view of the high/mid frequency resonator which comprises the embodiment of the invention.

### SUMMARY

In accordance with the present invention, an acoustic resonator design incorporated into a stereophonic headphone set, producing a haptic effect, and to reduce listening fatigue and distortion.

### REFERENCE NUMBERS IN DRAWINGS

1 Head pad

2 Housing assembly

3 Hanger screw

4 Ear pad

5 Hanger

2a Housing

2b Spacers, medium size

2c High/Mid frequency resonator assembly

2c1 High/Mid frequency resonator

2c1a Rigid flat plate-high/mid frequency resonator

2c1b Rigid projections, medium size-high/mid frequency resonator

2c1c Rigid projections, small size-high/mid frequency resonator

2c2 Second acoustic transducer

2d Low frequency acoustic resonator assembly

2d1 Rigid flat plate with rigid projections-low frequency resonator

2d2 Rigid spacer-low frequency resonator

2d3 Spacer-high/mid frequency resonator assembly

2d4 Second rigid flat plate-low frequency resonator

2d5 Mechanical fastener holes

2d6 Mechanical fastener-high/mid frequency resonator assembly

2d7 Rigid projections, medium size-low frequency resonator

2d8 Mounting plate for acoustic transducer

2d9 Rigid projections, small size-low frequency resonator

2d10 Rigid projections, large size-low frequency resonator

2d11 Mounting hole for acoustic transducer

2e Acoustic transducer

2f Mechanical fastener-low frequency resonator

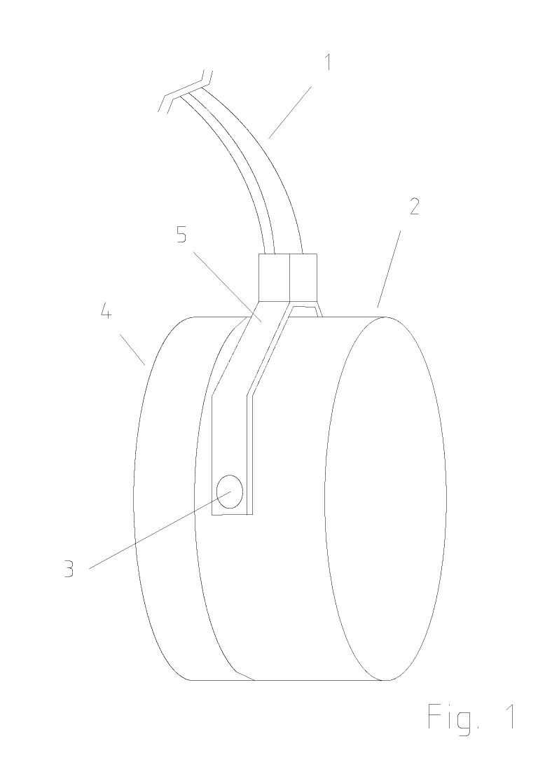

### Description of FIGS. 1-9

The drawing in FIG. 1 shows one half of a typical two channel stereophonic headphone assembly comprising a head pad 1, a housing assembly 2, which contains the sound reproducing elements, a hanger 5, for supporting the housing assembly 2, a hanger screw 3 (1 of 2) for mounting the housing assembly 2 to hanger 5, and an ear pad 4, which provides a cushion for the ear and head.

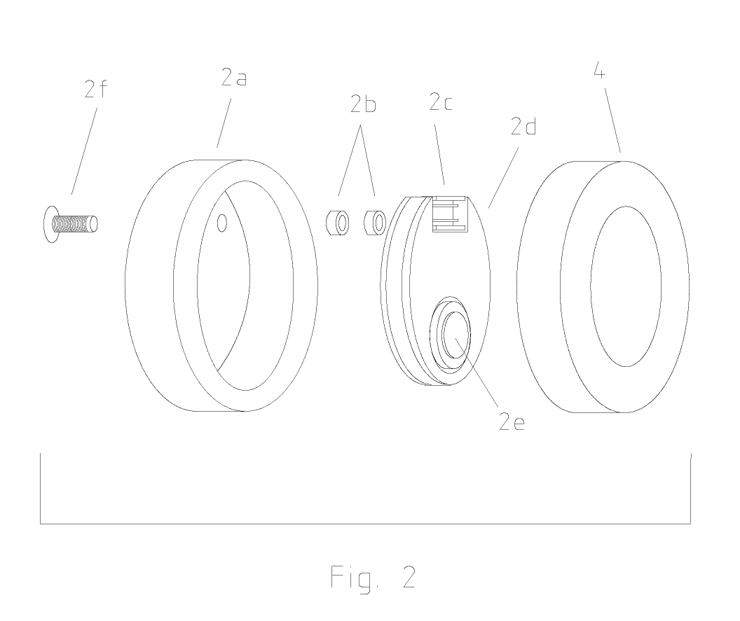

The drawing in FIG. 2 is an exploded diagram showing the major components of the housing assembly 2. A typical embodiment of the present invention is illustrated by the housing 2a, the spacers 2b, the mechanical fastener 2f (1 of 2), the high/mid frequency resonator assembly 2c, the low frequency resonator assembly 2d and 2e. The ear pad 4 is not part of the embodiment of the present invention.

The housing 2a, is made of any high density material that has good acoustic qualities. These would include, but are not limited to wood, plastic, and metal. The housing 2a has a cavity that is closed on one side. The cavity is larger in area than the low frequency resonator assembly 2d.

The spacers 2b are made of a medium density rubber or plastic material and separate the low frequency resonator assembly 2d and 2e from the housing 2a. The mechanical fastener 2f (1 of 2) is inserted through the closed side of housing 2a, the spacers 2b and into the low frequency resonator assembly 2d and 2e to the housing 2a. An ear pad 4 is attached to the housing 2a by mechanical or adhesive means. The ear pad 4 and the means to attach it to the housing 2a are not part of the embodiment of the present invention.

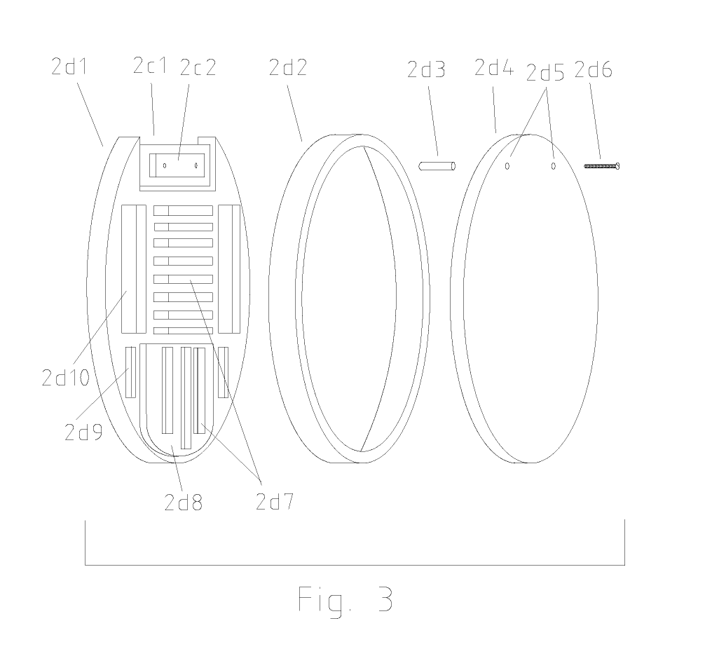

The drawing in FIG. 3 is an exploded diagram of the low frequency resonator assembly 2d. The rigid flat plate 2d1 is made of a high density material of uniform thickness such as, but not limited to, wood, plastic, or metal, and can be any size, number, or shape, to which are attached or machined into the rigid flat plate, the various sizes of resonator projections. The small size rigid projections 2d9, the medium size rigid projections 2d7, and the large size rigid projections 2d10 are made of a high density material such as, but not limited to, hardwood, plastic, or metal and resonate at different frequencies within the range of 20 Hz to 1200 Hz. The rigid projections can be arranged in any number, size, shape and pattern to achieve the desired acoustic quality. The rigid projections also provide an increase in the surface area of the acoustic resonator 2d providing good bass response from a practical headphone size. The mounting plate 2d8 holds an acoustic transducer which is attached with an adhesive or mechanical means to the opposite side of the rigid flat plate with the rigid projections 2d1. The rigid spacer 2d2 is made of a high density material to provide a gap between the rigid projections of 2d1 and the second rigid flat plate 2d4. The high/mid frequency resonator 2c1 and second acoustic transducer 2c2 form an assembly which is attached to the closed side of housing 2a with at least two mechanical fasteners 2d6 and at least two spacers 2d3 through holes 2d5. The high/mid frequency resonator 2c1 and the second acoustic transducer 2c2 are centered within a notch in the edge of the low frequency resonator assembly 2d and 2e with no contact with said low frequency resonator assembly 2d and 2e.

The drawing in FIG. 4 shows a front view of the rigid flat plate with rigid projections comprising the low frequency resonator 2d1 along with the position of the high/mid frequency resonator 2c1 and the second acoustic transducer 2c2, with respect to 2d1.

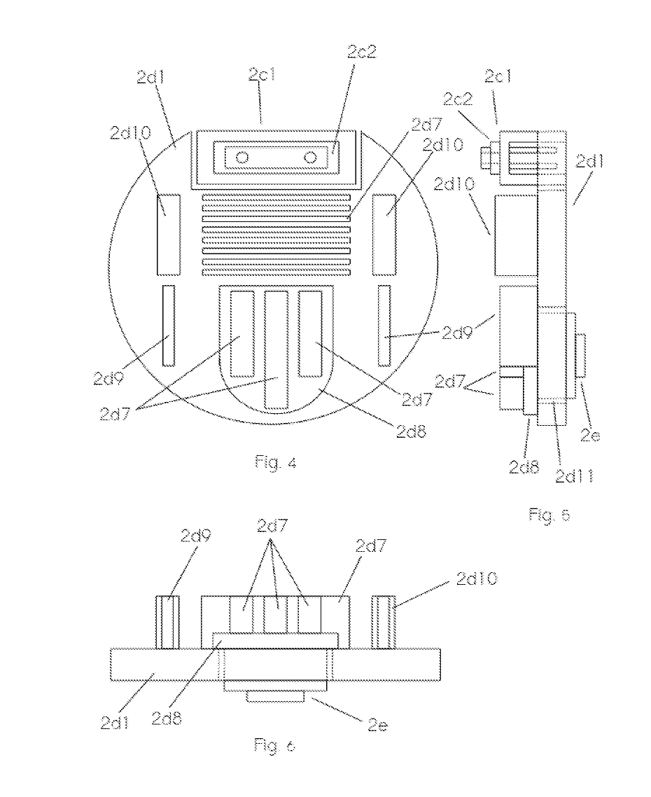

FIG. 5 is a side view showing an acoustic transducer 2e positioned in mounting hole 2d11 and attached to mounting plate 2d8. FIG. 6 is another side view of the low frequency resonator rigid flat plate with rigid projections and acoustic transducer 2e.

FIG. 7 is an exploded view of the high/mid frequency resonator 2c1 and an acoustic transducer 2c2.

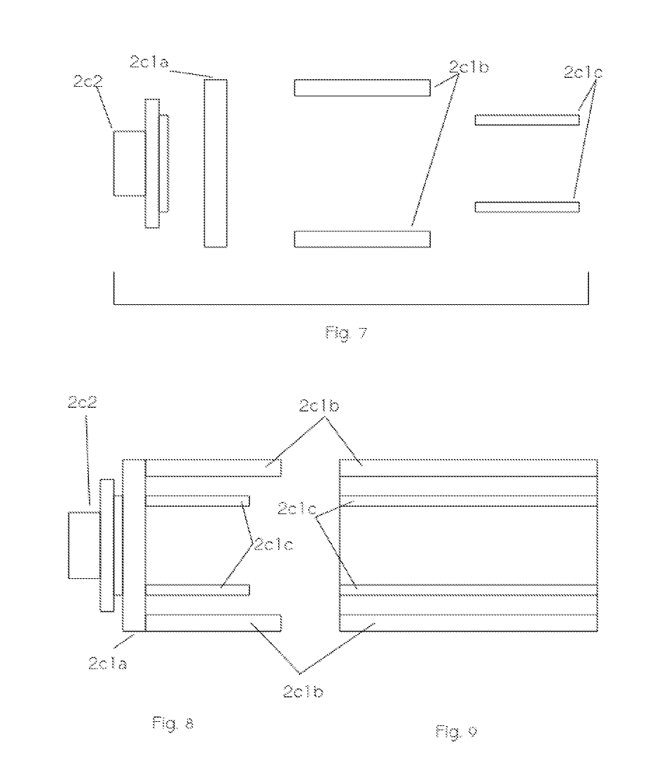

FIG. 8 is a side view of the high/mid frequency resonator 2c1. A second acoustic transducer 2c2 is attached to the closed side of the housing 2a with an adhesive or mechanical fastener. At least one large rigid projection 2c1b and at least one small rigid projection 2c1c are fastened to the back plate 2c1a with an adhesive or mechanical means as shown in side view FIG. 8.

FIG. 9 is a front view of the high/mid frequency resonator 2c1. The rigid flat plate 2c1a and the rigid projections 2c1b and 2c1c resonate within approximately 1200 Hz to 20,000 Hz and provide a surface area large enough for a more balanced high/mid frequency response with the bass response. The rigid flat plate 2c1a, and the rigid projections 2c1b and 2c1c are made of a rigid low density material such as, but not limited to, a softwood species or plastic, or a light weight metal, and has a uniform thickness.

### OPERATION

An electrical signal from an amplified source such as as a stereophonic audio amplifier, portable audio device, or smart phone, is sent through a conductive wire to the acoustic transducers. A crossover circuit that divides the signal into the low frequencies from approximately 20 Hz to 1200 Hz and the high/mid frequencies from approximately 1200 Hz to 20,000 Hz. This would provide an enhanced low distortion sound output. The crossover circuit can be located internally or externally of the headphone housing 2. The crossover circuit components can be varied to produce different frequency crossover points. The crossover circuit is not part of the embodiment of the present invention. The amplifier signal is then passed onto the acoustic transducers 2c2 and 2e.

The acoustic transducer 2e causes the low frequency resonator assembly 2d to react within the low frequency range of approximately 20 Hz to 1200 Hz and the second acoustic transducer 2c2 causes the resonator assembly 2c to react within the high/mid frequency range of approximately 1200 Hz to 20,000 Hz.

The small, medium, and large rigid projections resonate at different frequencies and also increase the surface area of the acoustic resonators to enhance the overall acoustic response. The enhanced response of the low frequency acoustic resonator also provides a haptic effect especially in the lower frequencies of approximately 20 Hz to 1200 Hz.

I claim:

1. An acoustic resonating device comprising at least two rigid flat plates spaced apart by a rigid spacer of a predetermined size and shape, wherein at least one rigid projection of a predetermined size , shape, material, and quantity, is attached to at least one said rigid flat plate in a predetermined position and including at least one acoustic transducer, and wherein at least one said acoustic resonating device is incorporated into a housing for producing enhanced bass response, a haptic effect, lower listening fatigue, and lower distortion of sound from an audio source.

2. The rigid flat plates of claim 1 are composed of a high density material of uniform thickness.

3. The rigid flat plates of claim 2 wherein at least one rigid flat plate has at least one rigid projection of claim 1 attached or machined into the surface of said rigid flat plate.

4. The rigid flat plate of claim 3 wherein said rigid flat plate has at least one acoustic transducer of claim 1 attached in a predetermined position.

5. The rigid flat plate of claim 4 is attached to one side of the rigid spacer of claim 1 in a manner by which said rigid projection of claim 3 faces said rigid spacer.

6. The rigid flat plate of claim 2 wherein a second rigid flat plate is attached to said rigid spacer of claim 5 in a manner that said second rigid flat plate is facing opposite said rigid flat plate of claim 5.

7. The rigid flat plate of claim 5, the rigid spacer of claim 5, and the second rigid flat plate of claim 6 form a sandwiched assembly in which at least one notch of a predetermined size and shape is formed into the outer edge of said sandwiched assembly.

8. The housing of claim 1 wherein said housing is composed of a high density material.

9. The housing of claim 8 wherein said housing has an internal cavity larger than said sandwiched assembly of claim 7.

10. The housing of claim 9 wherein said housing has one closed side.

11. The closed side of claim 10 wherein said closed side has at least 1 hole.

12. The hole of claim 11 wherein at least one mechanical fastener is inserted into said hole.

13. The mechanical fastener in claim 11 wherein at least one spacer is placed placed onto said mechanical fastener.

14. The sandwiched assembly of claim 7 is inserted into the internal cavity of claim 9 in a manner that said sandwiched assembly is centered within said said internal cavity.

15. The mechanical fastener of claim 13 wherein is inserted into the sandwiched assembly of claim 14 in a manner that said sandwiched assembly is mounted on the spacer of claim 13.

16. The closed side of claim 10 wherein at least one additional hole is formed.

17. The additional hole of claim 16 wherein at least one additional mechanical fastener of claim 12 is inserted into said additional hole.

18. The additional mechanical fastener of claim 17 wherein at least one additional spacer of claim 13 is placed onto said additional mechanical fastener.

19. The acoustic transducer of claim 1 wherein at least one additional said acoustic transducer is attached in a manner in which the additional mechanical fastener of claim 18 is inserted into said additional acoustic transducer in a manner by which said additional acoustic transducer is mounted on the additional spacer of claim 17, and in a manner by by which said additional acoustic transducer is centered within the notch of claim 7.

20. The rigid flat plate of claim 3 wherein at least one additional said rigid flat plate of a predetermined size, shape and material is attached to the additional acoustic transducer of claim 19 in a manner so that said additional rigid flat plate is centered within the notch of claim 7.
